(19) United States
(12) Patent Application Publication
(10) Pub. No.: US 2025/0065568 A1
(43) Pub. Date: Feb. 27, 2025

(54) METHOD, APPARATUS, AND SYSTEM FOR SUPPORT MATERIAL REMOVAL FROM A 3D-PRINTED OBJECT

(71) Applicant: ORYX ADDITIVE, INC., Tempe, AZ (US)

(72) Inventors: Noah TREMBLAY, Pepperell, MA (US); David M. DIETRICH, Chandler, AZ (US); William S. JOACHIM, JR., Florence, AZ (US); Keith L. JEFFCOAT, Cave Creek, AZ (US)

(21) Appl. No.: 18/717,413

(22) PCT Filed: Dec. 8, 2022
(86) PCT No.: PCT/US2022/081203

§ 371 Date: Jun. 6, 2024

Related U.S. Application Data
(60) Provisional application No. 63/287,449, filed on Dec. 8, 2021.
(60) Provisional application No. 63/335,185, filed on Apr. 26, 2022.

(51) Int. Cl. B29C 64/35; B08B 3/08; B29K 29/00

(52) U.S. Cl. CPC B29C 64/35; B08B 3/08; B29K 2029/04

(57) ABSTRACT

The present disclosure relates to a method, an apparatus, and a system for removing a support material from an additively manufactured part. The method comprises providing a chamber comprising a support surface; placing the additively manufactured part over the support surface in the chamber with a packet comprising a strong base in a solid form disposed within the packet; and filling the chamber with an aqueous solution to immerse the support material and packet contents, wherein the strong base dissolves into the aqueous solution.

### CROSS-REFERENCE TO RELATED APPLICATIONS

This disclosure claims the benefit, including the filing date, of both U.S. Provisional Patent No. 63/335,185, entitled “Method, Apparatus, and System for Support Material Removal from a 3D-Printed Object” which was filed on Apr. 26, 2022, and U.S. Provisional Patent No. 63/287,449, entitled “Method, Apparatus, and System for Support Material Removal from a 3D-Printed Object” which was filed on Dec. 8, 2021, the entire disclosures for both of which are hereby incorporated herein by this reference.

### TECHNICAL FIELD

The present disclosure relates to additive manufacturing technologies for building three-dimensional (3D) models and support structures. In particular, the present disclosure relates to methods, solutions, and apparatuses for removing support structures from 3D models built with additive manufacturing systems, such as extrusion-based additive manufacturing systems.

### BACKGROUND

Additive manufacturing processes, such as 3D printing (e.g., Selective Laser Sintering (SLS), Stereolithography (SLA), fused deposition modeling (FDM), material jetting (MJ), electron beam (e-beam), etc.) have enabled the production of parts having complex geometries that would never be possible through traditional manufacturing techniques, such as casting, injection molding, or forging. However, additive manufacturing produces parts that require significant efforts to remove unwanted support material. The support material is needed during the manufacturing process to support portions of the part as the part is being manufactured in order to achieve complex geometries. After the manufacturing process is completed, the unwanted support material must be removed and/or rough surfaces may need to be polished.

### SUMMARY

The present disclosure provides a method of removing a support material from an additively manufactured part, comprising: providing a chamber comprising a support surface; placing the additively manufactured part over the support surface in the chamber with a fabric coated or embedded with a strong base in a solid form; and filling the chamber with an aqueous solution to immerse the support material and fabric, wherein the strong base dissolves into the aqueous solution.

In some aspects, the strong base is selected from the group consisting of potassium hydroxide (KOH), sodium hydroxide (NaOH), barium hydroxide (Ba(OH)₂), cesium hydroxide (CsOH), strontium hydroxide (Sr(OH)₂), calcium hydroxide (Ca(OH)₂), lithium hydroxide (LiOH), rubidium hydroxide (RbOH), and a combination thereof. In some aspects, the strong base can be the results of any reactive material, such as sodium metal or reactive metals blended with silica for stability, that would, under normal workplace or shipping and handling conditions, result in the strong base or combinations thereof. In one aspect, the strong base is sodium hydroxide (NaOH).

In one aspect the fabric is a woven fabric. In another aspect, the fabric is a nonwoven fabric.

In certain aspects, the nonwoven fabric is a staple nonwoven fabric, a melt-blown nonwoven fabric, a spunbond nonwoven fabric, a combined spunbond and melt-blown nonwoven fabric, or a flashspun nonwoven fabric. In other aspects, the fabric comprises a fiber selected from the group consisting of polyethylene, polypropylene, polyethylene terephthalate, and a combination thereof.

In some aspects, the method further comprises adding a pH indicator to the aqueous solution to provide a visual indicator of a decrease in pH below about 13.0, below about 12.5, below about 12.0, below about 11.5, below about 11.0, below about 10.5, below about 10.0, below about 9.5 below about 9.0, below about 8.5, or below 8.0. In another aspect, the pH indicator is selected from the group consisting of Alizarine Yellow R, Indigo Carmine, and Universal Indicator. In some aspects, the pH indicator is coated or embedded in the fabric.

In certain aspects, the support material is a material used during Polyjet printing, Fused Deposition Modeling (FDM) printing, Fused Filament Fabrication (FFF) printing, Selective Thermoplastic Electrophotographic Process (STEP) 3D printing technology, and/or Material Jetting (MJ) printing. In one aspect, the support material is selected from the group consisting of SUP706, SUP707, SUP708, SR20, SR30, SR35, SR100, SR110, SW-100, and a combination thereof.

In other aspects, the present disclosure provides an apparatus for removing a support material of an additively manufactured part, comprising a fabric embedded or coated with: a strong base selected from the group consisting of potassium hydroxide (KOH), sodium hydroxide (NaOH), barium hydroxide (Ba(OH)₂), cesium hydroxide (CsOH), strontium hydroxide (Sr(OH)₂), calcium hydroxide (Ca(OH)₂), lithium hydroxide (LiOH), rubidium hydroxide (RbOH), and a combination thereof, wherein the strong base is in a solid form; and a pH indicator is selected from the group consisting of Alizarine Yellow R, Indigo Carmine, and Universal Indicator. In some aspects, the strong base can be the results of any reactive material, such as sodium metal or reactive metals blended with silica for stability, that would, under normal workplace or shipping and handling conditions, result in the strong base or combinations thereof.

In some aspects, the apparatus further comprises a chamber comprising a support surface to support an additively manufactured part, wherein the chamber is filled with an aqueous solution into which the strong base dissolves.

In yet other aspects, the present disclosure provides a system for removing a support material of an additively manufactured part, comprising: a chamber comprising a support surface; a fabric coated or embedded with a strong base in a solid form inside the chamber; an aqueous solution to immerse the support material and fabric, wherein the strong base dissolves into the aqueous solution; and a pH indicator selected from the group consisting of Alizarine Yellow R, Indigo Carmine, and Universal Indicator.

In one aspect, the system further comprises a heater, a pump, and a sensor for measuring temperature to enable heating of the aqueous solution to maintain its temperature within a range of about 29° C. to about 86° C.

These and other aspects of the present disclosure will become apparent in the detailed description that follows and by reference to the following figures.

### BRIEF DESCRIPTION OF THE DRAWINGS

FIG. 1A presents an example of a non-woven fabric pouch or bag.

FIG. 1B presents an example of the filled packet comprising a pouch comprising dissolvable material.

FIG. 1C presents an example of a non-dissolvable pouch from which contents can be poured into the chamber.

FIG. 1D presents an example of a dissolvable tablet, pill or pellet that can be placed into the chamber.

FIG. 2A shows a perspective view of the apparatus.

FIG. 2B shows perspective line drawing of the apparatus.

FIG. 3 shows a cut-way view of the apparatus with the tank area within the apparatus being shown.

FIG. 4 illustrates a close-up view of the tank area shown in FIG. 3, with the tank area being shown with a maximum liquid level fill line.

FIG. 5 presents an example of a large parts basket that may be used with the disclosure.

FIG. 6 presents an example of a small parts basket that may be used with the disclosure.

FIG. 7 illustrates a large parts basket being inserted or removed from the tank of the apparatus.

FIG. 8 shows an exploded view of example of a cleaning apparatus, the Oryx sca1200ht Assembly.

FIG. 9 shows an image of a 3D-printed object prior to support material removal.

FIG. 10 shows the corresponding 3D-printed object of FIG. 9 after support material is removed.

### DETAILED DESCRIPTION

As used herein and in the appended claims, the singular forms “a,” “an,” and “the” include plural referents unless the context clearly dictates otherwise. For example, “a” or “an” means “at least one” or “one or more.”

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and case of readability.

Unless otherwise specified, temperatures referred to herein are based on atmospheric pressure (i.e., one atmosphere).

The present disclosure describes finishing solutions for removing undesirable material from an FDM, Polyjet, Fused Filament Fabrication (FFF), Selective Thermoplastic Electrophotographic Process (STEP) 3D printing technology, and/or Material Jetting (MJ) 3D-printed object. MJ consists of Polyjet and Mimaki's printing process Undesirable material of an unfinished object is dissolved by a finishing solution that is in keeping with the disclosure, and in doing so provides a finished object.

As used herein, unless otherwise indicated, the term “support material” refers to material that is operatively arranged to support portions of an object during an additive manufacturing process, but which are undesired once the manufacturing process is complete. Support material can comprise the same material as the object that is being manufactured or can be made of a different material. Materials that can be removed during finishing include, but are not limited to, materials used during Polyjet 3D printing (e.g., SUP706, SUP707, SUP708, and combinations thereof), FDM 3D printing (e.g., SR20, SR30, SR35, SR100, SR110, and combinations thereof), MJ printing (e.g., SW-100) and/or Selective Thermoplastic Electrophotographic Process (STEP) 3D printing technology.

The support material itself can have a complex geometry and can also be extensive. Additionally, since additive manufacturing manufactures a part in discrete layers, the surface of a part is often rough, because adjacent layers may not end in similar locations thereby leaving a rough bumpy outer surface. Such a rough outer surface is unappealing from a visual standpoint, and the uneven surface can create stress concentrations, which could develop during testing or use of the part and lead to untimely failure of the part.

As used herein, unless otherwise indicated, the term “finishing” refers to removing undesirable material from a 3D-printed object so as to produce a finished object. Finishing can include one or more processes, including, but not limited to, removing undesirable metal powder, removing undesirable print material, removing undesirable support material and/or making rough surfaces smoother. Sometimes, in the 3D-printing industry, finishing may be referred to as “cleaning.”

A current option in the additive manufacturing industry is to manually remove the support material and manually finish the surface of a part to produce a smooth exterior surface of the part. Depending on the type of part, using manual labor can be cost prohibitive and can lead to excessive removal of material and/or an uneven surface. If a surface is finished unevenly or incompletely, stress concentrations could still be unintentionally prevalent, leading to untimely failure of the part. In addition, manual removal of unwanted support material and manual surface finishing lacks consistency over an extended period of time and from part to part. This manual removal/finishing may create a bottleneck in the production process since one technician can remove support material from only a single part at a time.

Another option is to use a machine, such as those providing a chemical bath, to remove support material and/or to perform surface finishing. However, such machines are limited in the type of process parameters that can be altered to tailor the process to a specific part. These machines require the attention of, and operation by, a technician while the machine is running, which does not completely eliminate the bottleneck issue. Additionally, if a technician is unaware that a machine is not set at the proper parameters, excessive material removal could occur, ruining the part.

To remove support material from rough surfaces, and to remove other undesirable material, chemicals may be applied to the object. These chemicals may be in the form of a liquid solution. Some finishing solutions are organic based and contain isopropanol (IPA), which has a low flash point, making it dangerous to work with. There is a need for a finishing solution that is primarily aqueous, and thus less toxic and less flammable.

Thus, there is a need for a method, solution, and apparatus for automatically and safely removing support material from a part made via additive manufacturing techniques without damaging the part itself. The finishing solution provided herein is primarily aqueous, and thus less toxic and less flammable. Additionally, embodiments of the present disclosure provide an alternative that seeks to remove the manual labor bottleneck of processing additive manufactured parts to achieve support removal.

Some finishing processes are mechanical in nature (e.g., abrasion techniques, such as sanding), and others are a combination of mechanical processes and chemical processes. Chemical finishing solutions may be caustic. In a conventional machine that uses chemical finishing solutions to remove undesirable material (e.g., undesirable support material), an unfinished 3D-printed object may be subjected to a process to remove undesirable material, and thereby provide a finished object. In one such process, the unfinished object is placed (e.g., partially or completely submerged) in a tank that contains (e.g., at least partially filled) a liquid finishing solution. While in the finishing solution, the object may be subjected to mechanical agitation, abrasion, and/or heating in order to remove undesirable material from the object. Mechanical agitation may occur by moving the liquid finishing solution (e.g., via a pump) and/or by using ultrasound. In other such processes, the object is subjected to a liquid spray. In those processes, the object is placed in a chamber, and a pump is used to force the liquid finishing solution through one or more nozzles, which both applies the finishing solution to the object and mechanically agitates the object. In such processes, the liquid may include chemical solvents to dissolve support material, and thereby create a finished or nearly finished form of the object. Heat from a heat source may be used to maintain the finishing solution at a desired temperature. The support material may be removed thermally, chemically, mechanically, or via a combination of two or more of these general processes.

Additive manufactured parts may be made using numerous different methods, classes of materials (e.g., plastics, metals), specific build materials (e.g., nylon within the plastics class, aluminum within the metals class) and support materials. Each method, class of material, and specific build material can have its own unique qualities and characteristics and thus may require different parameters for effective and efficient removal of support material. Additionally, for a given type, parts made by such an additive manufacturing process and/or materials may have very different geometries, including designs having more delicate features than others, which thus may require adjustments for effective and efficient removal of support material. The amount of fluid sprayed, the direction of spray (from top and/or bottom), the location of spray (e.g., left versus right side of part or top versus bottom side of part), the pressure at which fluid is pumped to the nozzles, as well as other parameters such as the make-up, temperature and pH of the fluid, can be adjusted to create different combinations of these parameters in order to efficiently and effectively remove a given type of support material for a given type of build material and geometric design of additive manufactured part(s).

In certain aspects, the temperature is maintained within an allowable range, such as for example, 29° C. to 86° C. or any range derived therefrom including 40° C. to 80° C., 45° C. to 75° C., 50° C. to 70° C., etc.

### Support Material

The present disclosure provides methods, systems, and solutions for removal of support material and support structures from a 3D-printed object. Non-limiting examples of suitable support material and support structures to be removed include those disclosed in Priedeman et al., U.S. Pat. No. 7,754,807; Hopkins et al., U.S. Patent Application Publication No. 2010/0096072; and Rodgers, U.S. patent application Ser. No. 13/081,956; and those commercially available under the trade designations “SR-10”, “SR-20”, “SR-30”, “SR-35”, “SR-100”, “SR-110”, “SUP-705”, “SUP-706”, “SUP-708” Support Materials from Stratasys, Inc., Eden Prairie, Minnesota including any combination thereof.

### Strong Bases

In some aspects, a strong base is used to remove the support material and/or support structure from the 3D-printed object. Non-limiting examples of strong bases employed for this purpose include:
Potassium hydroxide (KOH);
Sodium hydroxide (NaOH);
Barium hydroxide (Ba(OH)₂);
Cesium hydroxide (CsOH);
Strontium hydroxide (Sr(OH)₂);
Calcium hydroxide (Ca(OH)₂);
Lithium hydroxide (LiOH);
Rubidium hydroxide (RbOH);
the strong base can be the results of any reactive material, such as sodium metal or reactive metals blended with silica for stability, that would, under normal workplace or shipping and handling conditions, result in the strong base or combinations thereof; and
one or more of the above together.

In certain aspects, the strong base is sodium hydroxide.

### Fabric

The fabric pouch can be formed through heat sealing the edges or through a sewing process. The fabric itself serves to prevent the inner contents from dusting hazards, being exposed to excessive airflow or the hands of the user. The fabric may comprise woven, non-woven, or an additively manufactured fabric. In certain aspects, the fabric material is resistant to the conditions of the support removal process (i.e., high pH and high temperature such as 85° C.). Materials that are compatible with high pH and high temperature are polypropylene and polyethylene; however, other materials fitting these criteria are also suitable.

In certain aspects, the strong base is embedded in or coated on a woven fabric or a nonwoven fabric. As used herein, “nonwoven fabric” is a fabric-like material made from staple fiber (short) and long fibers (continuous long), bonded together by chemical, mechanical, heat or solvent treatment. The nonwoven fabric used can be any one of the following types.

Nonwoven fabrics are typically manufactured by putting small fibers together in the form of a sheet or web (similar to paper on a paper machine), and then binding them either mechanically (as in the case of felt, by interlocking them with serrated needles such that the inter-fiber friction results in a stronger fabric), with an adhesive, or thermally (by applying binder (in the form of powder, paste, or polymer melt) and melting the binder onto the web by increasing temperature).

Staple nonwovens are made in 4 steps. Fibers are first spun, cut to a few centimeters in length, and put into bales. The staple fibers are then blended, “opened” in a multistep process, dispersed on a conveyor belt, and spread in a uniform web by a wetlaid, airlaid, or carding/crosslapping process. Wetlaid operations typically use 0.25 to 0.75 in (0.64 to 1.91 cm) long fibers, but sometimes longer if the fiber is stiff or thick. Airlaid processing generally uses 0.5 to 4.0 in (1.3 to 10.2 cm) fibers. Carding operations typically use ˜1.5″ (3.8 cm) long fibers. Rayon used to be a common fiber in nonwovens but is now greatly replaced by polyethylene terephthalate (PET) and polypropylene (PP). Fiberglass is wetlaid into mats for use in roofing and shingles. Synthetic fiber blends are wetlaid along with cellulose for single-use fabrics. Staple nonwovens are bonded either thermally or by using resin. Bonding can be throughout the web by resin saturation or overall thermal bonding or in a distinct pattern via resin printing or thermal spot bonding. Conforming with staple fibers usually refers to a combination with melt blowing, often used in high-end textile insulations.

Melt-blown nonwovens are produced by extruding melted polymer fibers through a spin net or die consisting of up to 40 holes per inch to form long thin fibers which are stretched and cooled by passing hot air over the fibers as they fall from the die. The resultant web is collected into rolls and subsequently converted to finished products. The extremely fine fibers (typically polypropylene) differ from other extrusions, particularly spun bond, in that they have low intrinsic strength but much smaller size offering key properties. Often melt blown is added to spun bond to form spun melt (SM) or spun melt spun (SMS) webs, which are strong and offer the intrinsic benefits of fine fibers such as fine filtration and low pressure drop.

Spunlaid, also called spunbond, nonwovens are made in one continuous process. Fibers are spun and then directly dispersed into a web by deflectors or can be directed with air streams. This technique leads to faster belt speeds, and cheaper costs. Several variants of this concept are available, such as the REICOFIL machinery. PP spunbonds run faster and at lower temperatures than PET spunbonds, mostly due to the difference in melting points

Spunbond has been combined with melt-blown nonwovens, conforming them into a layered product called SMS (spun-melt-spun). Melt-blown nonwovens have extremely fine fiber diameters but are not strong fabrics. SMS fabrics, made completely from PP are water-repellent and fine enough to serve as disposable fabrics. Melt-blown is often used as filter media, being able to capture very fine particles. Spunlaid is bonded by either resin or thermally.

Flashspun fabrics are created by spraying a dissolved resin into a chamber, where the solvent evaporates.

Air-laid paper is a textile-like material categorized as a nonwoven fabric made from wood pulp. Unlike the normal papermaking process, air-laid paper does not use water as the carrying medium for the fiber. Fibers are carried and formed to the structure of paper by air.

Nonwovens can also start with films and fibrillate, serrate or vacuum-form them with patterned holes. Fiberglass nonwovens are of two basic types. Wet laid mat or “glass tissue” use wet-chopped, heavy denier fibers in the 6 to 20 micrometer diameter range. Flame attenuated mats or “batts” use discontinuous fine denier fibers in the 0.1 to 6 range. The latter is similar, though run at much higher temperatures, to melt-blown thermoplastic nonwovens. Wet laid mat is almost always wet resin bonded with a curtain coater, while batts are usually spray bonded with wet or dry resin. An unusual process produces polyethylene fibrils in a Freon-like fluid, forming them into a paper-like product and then calendering them to create TYVEK®.

Both staple and spunlaid nonwovens would have no mechanical resistance in and of themselves, without the bonding step. Several methods can be used:
thermal bonding
   use of a heat sealer
   using a large oven for curing
   calendering through heated rollers (called spunbond when combined with spunlaid webs), calenders can be smooth faced for an overall bond or patterned for a softer, more tear resistant bond
hydroentanglement: mechanical intertwining of fibers by water jets (also called spunlace)
ultrasonic pattern bonding: used in high-loft or fabric insulation/quilts/bedding
needlepunching/needlefelting: mechanical intertwining of fibers by needles
chemical bonding (wetlaid process): use of binders (such as latex emulsion or solution polymers) to chemically join the fibers; a more expensive route uses binder fibers or powders that soften and melt to hold other non-melting fibers together
one type of cotton staple nonwoven is treated with sodium hydroxide to shrink bond the mat; the caustic causes the cellulose-based fibers to curl and shrink around one another as the bonding technique
one unusual polyamide (Cerex) is self-bonded with gas-phase acid
melt-blown: fiber is bonded as air attenuated fibers intertangle with themselves during simultaneous fiber and web formation.

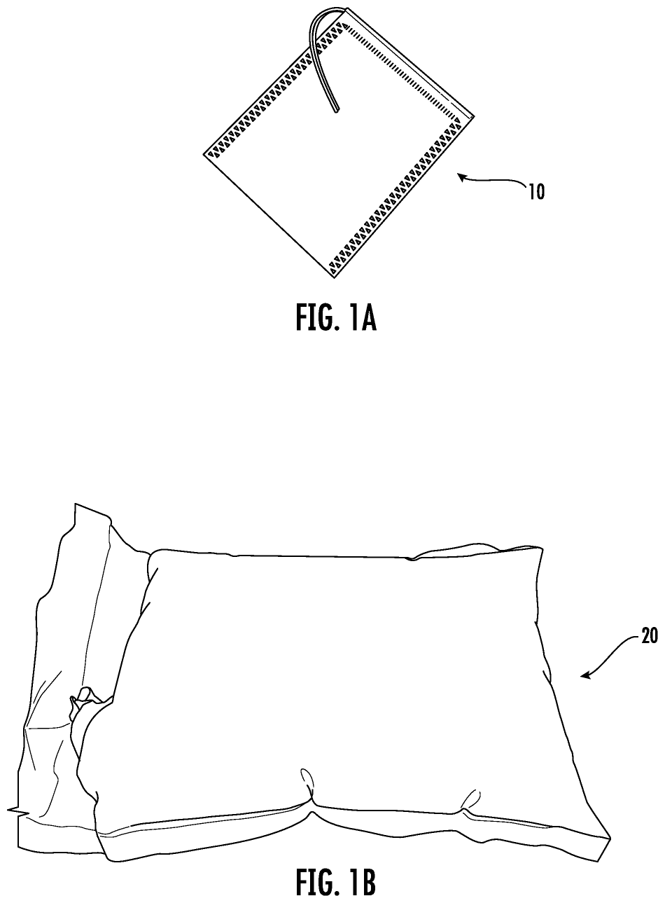

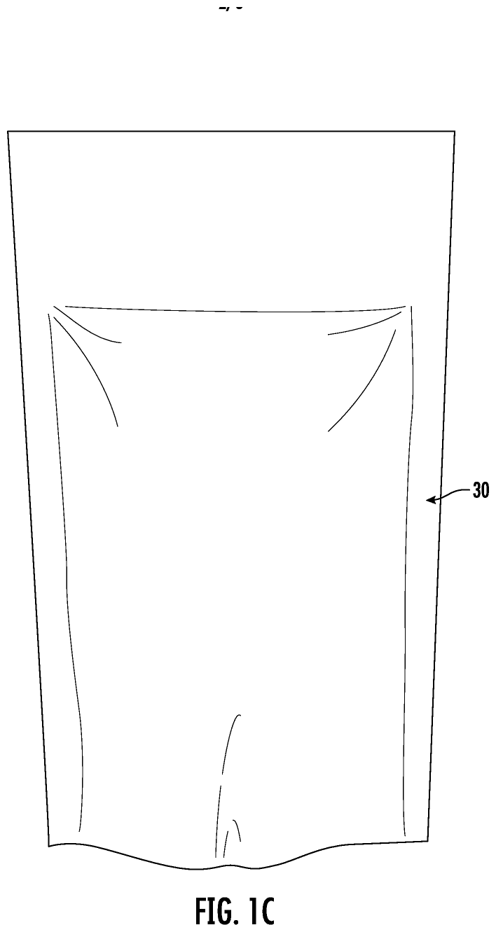

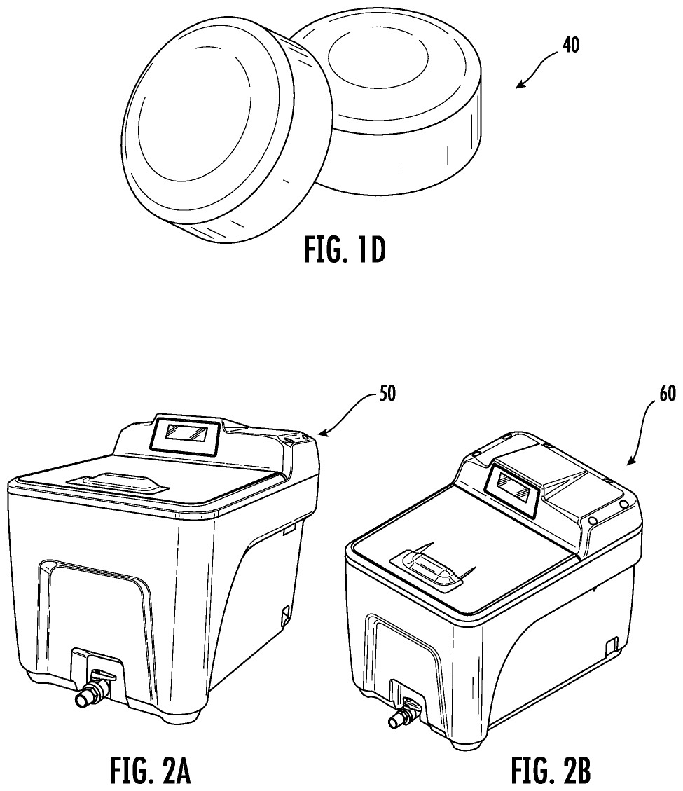

An example of a non-woven fabric pouch or bag 10 is shown below in FIG. 1A.

### Packet

The method of, or apparatus for, removing a support material from an additively manufactured part may comprise a packet comprising a strong base in a solid form disposed within the packet. The packet may be formed of two parts: (i) first a “pouch” which may comprise an outer container, bag, or holding/containing/restraining material, and (ii) the strong base in solid form disposed within the pouch. The pouch may be formed of or comprise one or more of: (a) a fabric—as described above, (b) a fabric coated or embedded with dissolvable material, (c) a dissolvable material, and (d) a rigid or semi-rigid material that may or may not be dissolvable. When the pouch is formed of the rigid or semi-rigid material, the pouch may made by additive manufacturing or other suitable process. An example of the filled packet 20 comprising a pouch comprising dissolvable material is illustrated below in FIG. 1B.

In some aspects, the fabric may be coupled with a soluble material to form a composite material. The soluble material may be a film that is laminated to the fabric, and may also be a liquid or gel that is sprayed, painted, printed, rolled, or otherwise applied to the fabric. Additionally, the fabric may also be dipped into a container, tub, or vat of soluble material and then removed after soluble material from the container, tub, or vat is transferred to the fabric or becomes a part of the pouch. In an aspect, a minimal thickness of soluble film may be applied or laminated as a barrier layer to the fabric to provide strength to contain the powder within the packet. In another aspect, the soluble film is thick enough to provide both strength, as well as a barrier to moisture, vapor, and gas or air that might otherwise interact with the material (such as the strong base in solid form) within the packet.

In certain aspects the soluble film is one or more of poly vinyl alcohol (PVA), cellulose, poly vinyl alcohol acetate co-polymers, bio-based polymer, gelatin, a polysaccharide, and weak glues that are soluble or would dissolve in a water or aqueous bath. In such cases, the packet and contents can both be added to the tank.

In some instances, groups of packets may be made together and be delivered as a chain or string of attached packets, that may be formed of any desirable length. A desired number of packets may be separated from the chain of packets for use. In some instances, more packets may be used to increase a strength of the solution, or to create a larger amount of the solution.

### Non-Dissolvable Pouch

In some embodiments, the packet may be a non-dissolvable pouch 30 that contains the strong base. When at least a portion of the packet or pouch 30 is not dissolvable, the non-dissolvable portion may be a reusable material or cartridge that may be refilled, reloaded, or reused One example is shown in FIG. 1C. In some instances, rather than placing the packet directly into the chamber, the contents may be poured into the chamber. The non-dissolvable pouch 30 may be disposed of after the contents are added to the chamber. The non-dissolvable pouch 30 can be made of any suitable material that can contain the strong base for a period that avoids degradation that prevents degradation to maintain a suitable shelf life. Any non-dissolvable pouch 30 size and shape that allows for storing the strong base may be utilized. In some embodiments, the non-dissolvable pouch 30 is square or rectangular.

### Pill, Pellet or Tablet

Other embodiments involve compressing material into pill, pellet, or tablet 40. The pill, pellet or tablet 40 comprise the strong base. The shape of the pill, pellet or tablet 40 can be like a pharmaceutical pill, pool chlorine tablet, granules or any other suitable shape. The powder/material can be pressed and bound, so it is stable. It may further comprise an outside container, layer, or coating to help hold it together. Such pills, pellets and tablets 40 can be added directly to the tank to dissolve.

In some instances, the concentrate may be a single piece of sodium metal in a soluble heated sealed pouch. The concentrate may also be a sodium metal melted with silica gel under vacuum and the pouch may be a nonwoven fabric with a thin barrier layer of a soluble film.

In an aspect, certain handling of materials, such as the strong base in solid form, may be implemented during manufacturing to reduce a risk of injury or damage. A mostly static environment with non-flowing or low flowing air, gas, or fluid above the strong base concentrate or concentrate may be maintained. A low humidity environment of less than or equal to 20% humidity, less than or equal to 10% humidity, less than or equal to 5% humidity, less than or equal to 3% humidity, or less than or equal to 1% humidity, may be employed to prevent or limit reaction of the strong base with water vapor in the ambient air. Manufacturing equipment and supplies may be made from materials that are inert with respect to caustic materials, such as the strong base, and may include, e.g., polyethylene and polypropylene. A robust spill prevention protocol and robust emergency spill protocol may also be designed, trained, and implemented to contain, and dispose of spilled materials.

Use of the soluble material may improve safety of the final product, so as to prevent the exchange of air and moisture from outside the packet to the contents of the packet, which could cause undesirable chemical reactions before the packet is place in a bath or chamber. Alternatively, a packet formed of a transmissible membrane or fabric that permits interactions with ambient air, moisture, or other conditions may be used but then be further packaged in a outer wrapper, packaging, or disposable environmental containment element (hereinafter “wrapper”) that prevents interactions with ambient air, moisture, or other conditions. When the wrapper is used, the wrapper may be discarded before the packet is used or placed in the container or bath.

### pH Indicators

In one aspect, a pH indicator is embedded in or coated on the nonwoven fabric. In another aspect, a pH indicator is added separately with the nonwoven fabric to the solution containing the support material.

A pH indicator is a halochromic chemical compound added in small amounts to a solution so the pH (acidity or basicity) of the solution can be determined visually. As the strong base is neutralized and the pH decreases in the solution containing the support material, the pH indicator provides a visual indication of the need to replace the used non-woven fabric with a fresh non-woven fabric with strong base. In one aspect, a drop in pH below about 13.0, below about 12.5, below about 12.0, below about 11.5, below about 11.0, below about 10.5, or below about 10.0 indicates the need to replace the nonwoven fabric with a fresh nonwoven fabric containing a strong base. In certain aspects, a drop in pH below about 11.0 indicates the need to replace the nonwoven fabric with a fresh nonwoven fabric containing a strong base.

Non-limiting examples of pH indicators that may be used are outlined in Table 1. In one aspect, the pH indicator is Alizarine Yellow R and a color change from blue to yellow indicates the need to replace the nonwoven fabric. In another aspect, the pH indicator is Indigo Carmine and a color change from yellow to blue indicates the need to replace the nonwoven fabric. In another aspect, the pH indicator is Universal Indicator and a color change from indigo or violet to blue indicates the need to replace the nonwoven fabric.

TABLE 1
pH Indicators Indicating Neutralization of Sodium Hydroxide

| | pH Range in which Color | Color Change as pH |
|---|---|---|
| Indicator | Change Occurs | Increases |
| Alizarine Yellow R | 10.1-12.0 | yellow to blue |
| Indigo Carmine | 11.4-13.0 | blue to yellow |
| Universal Indicator | about 11 | blue to indigo or violet |

In some aspects, one or more surfactants and anti-foaming agents are added to the aqueous solution. In other aspects, no surfactants or anti-foaming agents are added.

### Apparatuses and Systems for Support Material Removal

A method of removing a support material from an additively manufactured part, may include providing a chamber comprising a support surface. As example of substrate removal assembly or cleaning apparatus (the Sca1200ht™ Assembly by Oryx™) is shown in the perspective view of the apparatus 50 shown in FIG. 2A and the perspective line drawing of the apparatus 60 in FIG. 2B.

FIG. 3, included below, shows a cut-way view of the apparatus 60 with the tank area within the apparatus being shown. This figure shows a level and temperature sensor 70, pump assembly 80, pump intake screen 90, nozzle 100, strainer 110, rear support bracket 120, and heater shield 130.

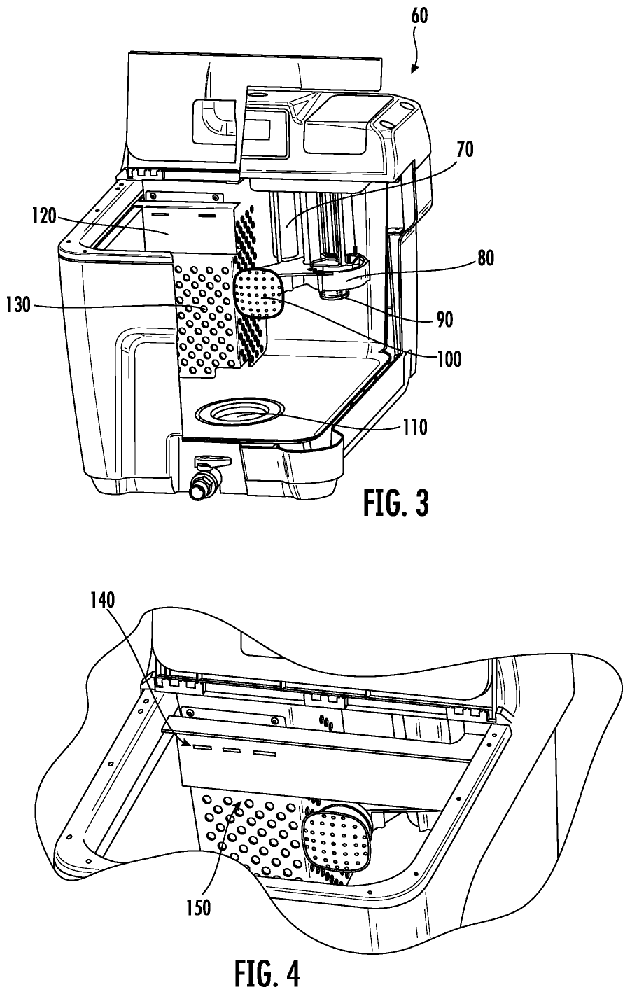

FIG. 4, included below, illustrates a close-up view of the tank area shown in FIG. 3, with the tank area being shown with a minimum liquid level 150 line and maximum liquid level 140 fill line.

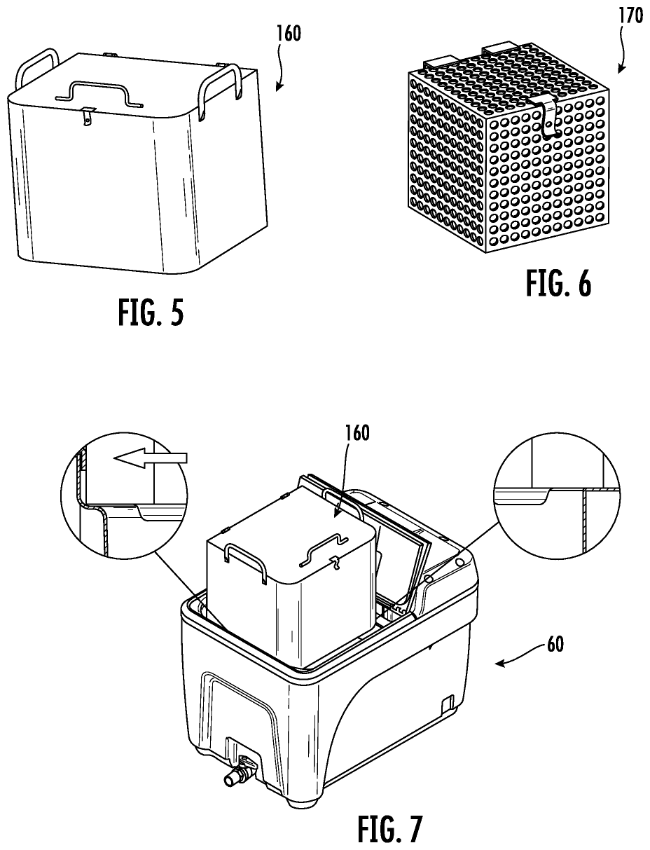

The tank area can receive a parts basket into which one or more additively constructed (or 3D-printed) parts may be disposed for the cleaning of the support material. Examples of parts baskets that may be used include the large parts basket 160 shown in FIG. 5 and the small parts basket 170 shown in FIG. 6.

The additively manufactured part may be placed over, on, or within, the support surface in the chamber or tank area. A nonwoven fabric coated or embedded with a strong base in a solid form may also be placed over, on, or within, the support surface in the chamber or tank area with the additively manufactured part. In some instances, the additively manufactured part will be disposed within the parts basket. The nonwoven fabric with a strong base in solid form will be placed within the tank and outside the parts basket, or in the tank and within the parts basket.

The chamber or tank area may be filled with an aqueous solution, either before or after the additively manufactured part, part basket, or both the manufactured part and the part basket are placed within the tank. The aqueous solution in the tank may be used for immersing the support material and nonwoven fabric, and for dissolving the strong base into the aqueous solution for removal of the support material. As used herein “immerse” included both total submersion as well as partial submersion, such that immersing the nonwoven fabric into the aqueous solution comprises the nonwoven fabric being totally submerged and completely covered by the aqueous solution, as well as the nonwoven fabric floating on a surface and being partially submerged and partially outside of the aqueous solution.

FIG. 7 illustrates a large parts basket 160 being inserted or removed from the tank of the apparatus 60.

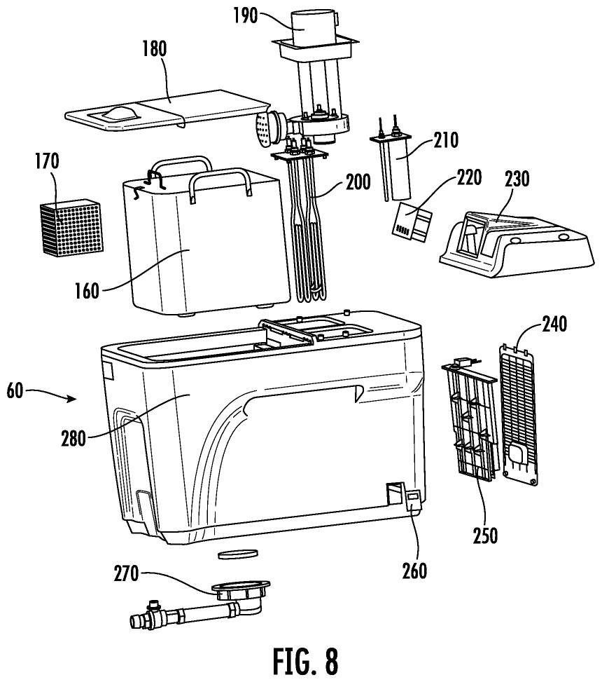

FIG. 8 shows an exploded view of example of a cleaning apparatus 50, the Oryx sca1200ht Assembly. Part shown are a large basket 160, small basket 170, lid 180, pump subassembly 190, heater subassembly 200, sensor subassembly 210, display control panel subassembly 220, top cover 230, rear access panel 240, PCB subassembly 250, power switch and plug 260, drain subassembly 270 and case/tank subassembly 280.

The methods, apparatuses, and systems outlined herein provide several important advantages. The use of a fabric (e.g., a packet or pouch) that contains or is coated or embedded with a strong base provides improved handling safety. There is no inhalation hazard as with dusts or powders nor are there splash hazards common with liquid chemicals. The fabric with strong base is not only safe to handle but it is also easier to package and ship. In addition, the strong base present on the fabric dissolves quickly and efficiently in the aqueous solution and can be provided at lower costs compared to other commercial products.

There are several additional advantages provided by the methods, apparatuses, and systems outlined herein. The strong base (e.g., sodium hydroxide powder or pellet) starts to dissolve in open air and heat up very quickly. The heat and the extreme caustic solution that forms on the surface of the pellets are both very dangerous, and even more so together at once. By putting the caustic powder or pellets within the fabric pouch, the user is protected from both hazards. The air flow over the pellets or powder is significantly reduced being within the pouch. Also, if water comes in contact with the pouch, the dissolution of the contents is slowed down significantly due to the permeability of the fabric. However, once the pouch is added to the tank, the heat, circulation, and time will help dissolve and release the materials safely into the tank.

The present disclosure is further illustrated by the following examples that should not be construed as limiting.

### EXAMPLES

### Example 1. Procedures for Removing Support Material from 3D-Printed Object

The following procedure is an example of a process used for the removal of support material from a 3D-printed object.
1. Select a temperature setting for the aqueous solution in the chamber (e.g., between 30° C. and 85° C.). Allow the aqueous solution to reach this temperature prior to adding the 3D-printed object and the packet to the aqueous solution. A pump is used to recirculate the aqueous solution through a heater until the desired temperature is reached.
2. Load the 3D-printed object onto the support structure in the chamber.
3. Add the packet with the strong base to the aqueous solution.
4. Adjust the level of the aqueous solution so that the 3D-printed object is completely immersed.
5. Allow the pump to continue to circulate the aqueous solution unit the support material has completely dissolved from the 3D-printed object.
6. Drain the aqueous solution and replace with a fresh aqueous solution and a new packet with strong base when the time required to dissolve the support material becomes longer than usual or the indicator indicates it is time to change the aqueous solution, such as, e.g., the pH indicator has changed color indicating a drop in pH below the recommended threshold. Allow the aqueous solution to cool to about 30° C. prior to draining it.

Another example of a procedure for the removal of support material from a 3D-printed object proceeds as follows. The process of removing support material begins with filling the tank with about 11 gallons of tap water and selecting the desired temperature for the parts from which supports will be removed. The user removes a packet from a larger container containing many packets and/or removes the packet from its packaging and hangs the packet by the string or loop such that the packet may hang and become submerged in the water. The inner contents of the packet will slowly dissolve as the temperature of the tank rises to achieve the set temperature. The user can add parts to dissolve and continue to do so until the bath changes from yellow to blue, for example, or until the pH reaches about 11.4. Once the bath reaches about pH 11.4, the user may drain the solution into a different tank to dispose of as aqueous waste through a hazardous waste service or use a method to remove the hazardous dissolved solids from the aqueous solution to produce solid waste and a clear run-off that would be suitable to meet rigorous municipal standards.

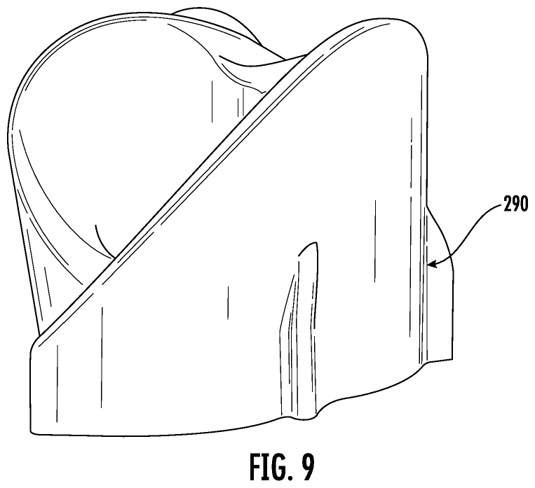

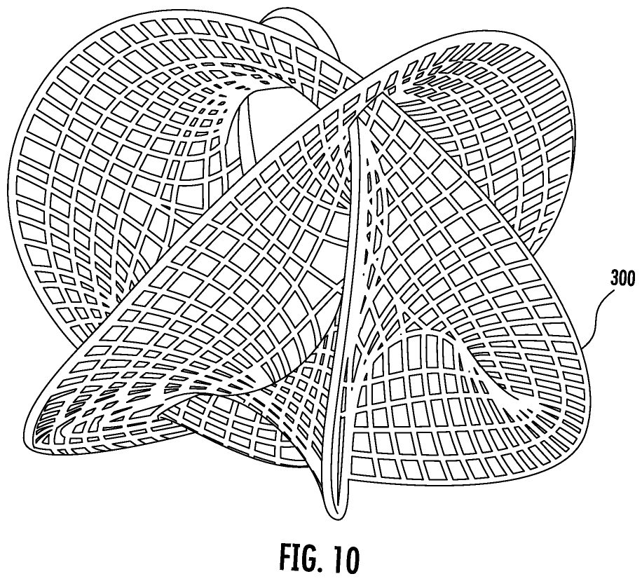

An image of a 3D-printed object prior to support material removal 290 is presented in FIG. 9 with the corresponding 3D-printed object after support material removal 300 shown in FIG. 10.

All headings are for the convenience of the reader and should not be used to limit the meaning of the text that follows the heading, unless so specified.

Unless defined otherwise, all technical and scientific terms herein have the same meaning as commonly understood by one of ordinary skill in the art to which this disclosure belongs. Although any methods and materials, similar or equivalent to those described herein, can be used in the practice or testing of the present disclosure, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present disclosure is not entitled to antedate such publication by virtue of prior disclosure.

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

What is claimed is:

1. A method of removing a support material from an additively manufactured part, comprising:
providing a chamber comprising a support surface;
placing the additively manufactured part over the support surface in the chamber with a packet comprising a strong base in a solid form disposed within the packet; and
filling the chamber with an aqueous solution to immerse the support material and packet contents, wherein the strong base dissolves into the aqueous solution.

2. The method of claim 1, wherein the packet comprises: (i) a non-dissolvable pouch, (ii) a dissolvable pill, pellet, or tablet, (iii) a fabric, (iv) a fabric coated or embedded with dissolvable material, or (v) a dissolvable material.

3. The method of claim 2, wherein the dissolvable material is polyvinyl alcohol-based.

4. The method of any one of claims 1-3, wherein the strong base is selected from the group consisting of potassium hydroxide (KOH), sodium hydroxide (NaOH), barium hydroxide (Ba(OH)₂), cesium hydroxide (CsOH), strontium hydroxide (Sr(OH)₂), calcium hydroxide (Ca(OH)₂), lithium hydroxide (LiOH), rubidium hydroxide (RbOH), and a combination thereof.

5. The method of claim 4, wherein the strong base is sodium hydroxide (NaOH).

6. The method of any one of claims 2 to 5, wherein the fabric is a nonwoven fabric selected from the group consisting of staple nonwoven fabric, a melt-blown nonwoven fabric, a spunbond nonwoven fabric, a combined spunbond and melt-blown nonwoven fabric, and a flashspun nonwoven fabric.

7. The method of any one of claims 2 to 6, wherein the fabric comprises a fiber selected from the group consisting of polyethylene, polypropylene, polyethylene terephthalate, and a combination thereof.

8. The method of any one of claims 1 to 7, further comprising adding an indicator to the aqueous solution to determine whether the aqueous solution should be changed.

9. The method of any one of claims 1 to 8, wherein the indicator comprises a pH indicator to the aqueous solution to provide a visual indicator of a decrease in pH below about 13.0, below about 12.5, below about 12.0, below about 11.5, below about 11.0, below about 10.5, below about 10.0, below about 9.5 below about 9.0, below about 8.5, or below 8.0.

10. The method of claim 6, wherein the pH indicator is selected from the group consisting of Alizarine Yellow R, Indigo Carmine, and Universal Indicator.

11. The method of claim 6 or 7, wherein the indicator is coated or embedded in the packet.

12. The method of any one of claims 1 to 8, wherein the support material is a material used during Polyjet printing, Fused Deposition Modeling (FDM) printing, Fused Filament Fabrication (FFF) printing, Selective Thermoplastic Electrophotographic Process (STEP) 3D printing technology, and/or Material Jetting (MJ) printing.

13. The method of claim 9, wherein the support material is selected from the group consisting of SUP706, SUP707, SUP708, SR20, SR30, SR35, SR100, SR110, SW-100, and a combination thereof.

14. An apparatus for removing a support material of an additively manufactured part, comprising a packet comprising:
a strong base selected from the group consisting of potassium hydroxide (KOH), sodium hydroxide (NaOH), barium hydroxide (Ba(OH)₂), cesium hydroxide (CsOH), strontium hydroxide (Sr(OH)₂), calcium hydroxide (Ca(OH)₂), lithium hydroxide (LiOH), rubidium hydroxide (RbOH), and a combination thereof, wherein the strong base is in a solid form; and
wherein the strong base in contained within (i) a non-dissolvable pouch, (ii) a dissolvable pill, pellet, or tablet, (iii) a fabric, (iv) a fabric coated or embedded with dissolvable material, or (v) a dissolvable material.

15. The apparatus of claim 14, wherein the dissolvable material is polyvinyl alcohol-based.

16. The apparatus of claim 14 or 15, further comprising an indicator to the aqueous solution to determine whether the aqueous solution should be changed.

17. The apparatus of claim 16, wherein the indicator comprises a pH indicator selected from the group consisting of Alizarine Yellow R, Indigo Carmine, and Universal Indicator.

18. The apparatus of any one of claims 14-17, wherein the strong base is sodium hydroxide (NaOH).

19. The apparatus of any one of claims 14-18, wherein the fabric is a nonwoven fabric selected from the group consisting of a staple nonwoven fabric, a melt-blown nonwoven fabric, a spunbond nonwoven fabric, a combined spunbond and melt-blown nonwoven fabric, and a flashspun nonwoven fabric.

20. The apparatus of any one of claims 14 to 19, wherein the fabric comprises a fiber selected from the group consisting of polyethylene, polypropylene, polyethylene terephthalate, and a combination thereof.

21. The apparatus of any one of claims 14 to 20, further comprising a chamber comprising a support surface to support an additively manufactured part,
wherein the chamber is filled with an aqueous solution into which the strong base dissolves.

22. A system for removing a support material of an additively manufactured part, comprising:
a chamber comprising a support surface;
a packet comprising a strong base in a solid form inside the chamber;
an aqueous solution to immerse the support material and packet, wherein the strong base dissolves into the aqueous solution; and
an indicator configured to determine when the aqueous solution should be changed.

23. The system of claim 22, wherein the indicator is a pH indicator selected from the group consisting of Alizarine Yellow R, Indigo Carmine, and Universal Indicator.

24. The system of claim 22 or 23, wherein the strong base is selected from the group consisting of potassium hydroxide (KOH), sodium hydroxide (NaOH), barium hydroxide (Ba(OH)₂), cesium hydroxide (CsOH), strontium hydroxide (Sr(OH)₂), calcium hydroxide (Ca(OH)₂), lithium hydroxide (LiOH), rubidium hydroxide (RbOH), and a combination thereof.

25. The system of any one of claims 22-24, wherein the packet comprises: (i) a non-dissolvable pouch, (ii) a dissolvable pill, pellet, or tablet, (iii) a fabric, (iv) a fabric coated or embedded with dissolvable material, or (v) a dissolvable material.

26. The system of claim 25, wherein the fabric is a nonwoven fabric selected from the group consisting of a staple nonwoven fabric, a melt-blown nonwoven fabric, a spunbond nonwoven fabric, a combined spunbond and melt-blown nonwoven fabric, or a flashspun nonwoven fabric.

27. The system of claim 26, wherein the fabric comprises a fiber selected from the group consisting of polyethylene, polypropylene, polyethylene terephthalate, and a combination thereof.

28. The system of any one of claims 22 to 27, further comprising a heater, a pump, and a sensor for measuring temperature to enable heating of the aqueous solution to maintain its temperature within a range of about 29° C. to about 86° C.

29. The system of any one of claims 22-28, wherein the dissolvable material is polyvinyl alcohol-based.
